(19) United States
(12) Patent Application Publication
(10) Pub. No.: US 2025/0080460 A1
(43) Pub. Date: Mar. 6, 2025

(54) DATA PACKETS WITH MEMORY ACCESS PROTOCOLS IN HIGH-SPEED PACKET NETWORKS

(71) Applicant: MELLANOX TECHNOLOGIES, LTD., Yokneam (IL)

(72) Inventors: Mark Hummel, Franklin, MA (US); Jonathan Mercer Owen, Northborough, MA (US); Gregory Thorson, Eau Claire, WI (US); Glenn Dearth, Groton, MA (US); Lion Levi, Yavne (IL); Lior Hodaya Bezen, Tel Aviv (IL); Itamar Rabenstein, Petach-Tiqwa (IL); Ami Gidon Marelli, Herzliya (IL); Roee Levy Leshem, Tel Aviv (IL); Liron Mula, Hertzlia (IL); Alex Netes, Rehovot (IL); Eyal Srebro, Kfar Yehoshua (IL)

(21) Appl. No.: 18/240,549

(22) Filed: Aug. 31, 2023

(51) Int. Cl. H04L 45/7453; H04L 69/22

(52) U.S. Cl. CPC H04L 45/7453; H04L 69/22; G06F 12/0615; G06F 2212/154

(57) ABSTRACT

Systems and methods herein are for one or more processing units to be associated with at least one switch or router and to enable the at least one switch or router to receive a communication from a source host machine, where the communication includes a request associated with memory access protocols of a memory space of a destination host machine, and where the communication is to be provided to the destination host machine to enable subsequent communications from the source host machine that are based in part on the memory access protocols received in response to the request.

### TECHNICAL FIELD

At least one embodiment pertains to communication in high-speed (HS) data networks using header modification to include memory access protocols of a memory space of a destination host machine.

### BACKGROUND

A high-speed data network can network together multiple processing units of different host machines. The processing units may be graphics processing units (GPUs) in the different host machines that may be networked together via the high-speed data network, which provides higher bandwidth and lower latency communications between the different host machines. The processing units can communicate and share data directly using such a data network, rather than going through a central processing unit (CPU), which can increase an overall performance of a system having such host machines and in such a data network. Further, communications in these data networks occur using a series of interconnected switches or routers, which are responsible for routing data packets between the host machines of the network. The switches or routers utilize internal hash functions at each route layer to determine egress ports of communication of packets from a host machine. Polarization of traffic flow can occur as a result of one or more switches or routers in one or more route layers determining to use the same hash function amongst them or within itself, repeatedly, which results in the one or more switches or routers determining or selecting the same egress ports for different traffic onward traffic flow.

### BRIEF DESCRIPTION OF DRAWINGS

FIG. 1 illustrates a system that is subject to header modification to include associations with memory access protocols and hashing in high-speed data networks, according to at least one embodiment;

FIG. 2 illustrates aspects of a system for header modification to include associations with memory access protocols and hashing, according to at least one embodiment;

FIG. 3 illustrates further aspects of a system including a centralized controller for at least the hashing in header modifications that include associations with memory access protocols, according to at least one embodiment;

FIG. 4A illustrates still further aspects of a system for header modification to include associations with memory access protocols and hashing, according to at least one embodiment;

FIG. 4B illustrates details of the associations with memory access protocols, according to at least one embodiment;

FIG. 5A illustrates a process flow for a system for header modification to include associations with memory access protocols and hashing, according to at least one embodiment;

FIG. 5B illustrates a process flow for a system for header modification to include associations with memory access protocols and hashing, according to at least one embodiment;

FIG. 6 illustrates process flow for a system for header modification to include associations with memory access protocols and hashing, according to at least one embodiment; and

FIG. 7 illustrates a process flow for a system for header modification to include associations with memory access protocols and hashing, according to at least one embodiment.

### DETAILED DESCRIPTION

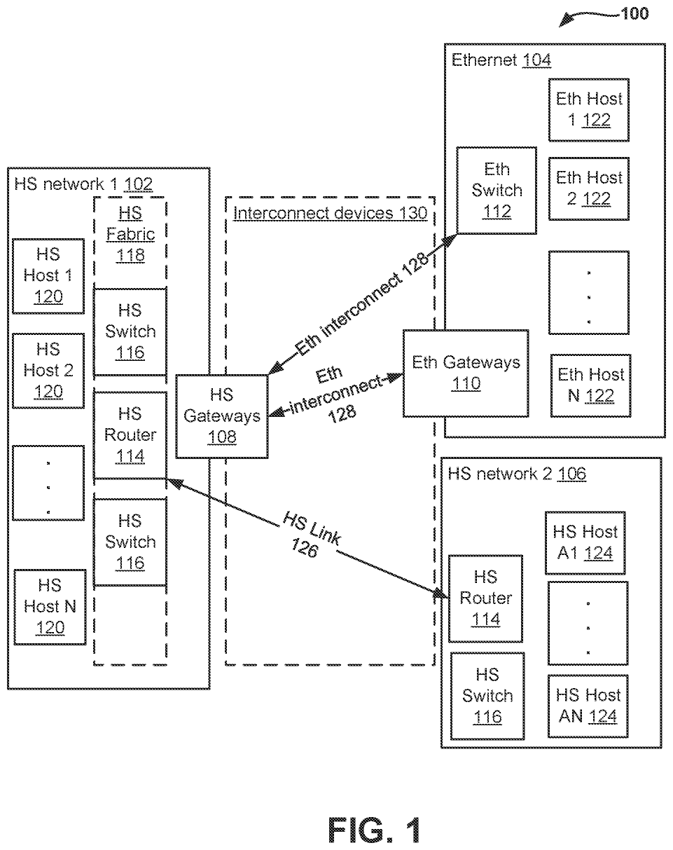

In at least one embodiment, FIG. 1 illustrates a system 100 that is subject to header modification to include associations with memory access protocols and a hashing, as detailed herein. In at least one embodiment, such associations may include at least one of a request or a response associated with the memory access protocols. The system 100 includes one or more high speed (HS) data networks 1 102, 2 106 that may be peer to peer networks. HS data networks 1 102, 2 106 are able perform header modification to include associations with (such as, a request for) memory access protocols and a hash to provide efficient and properly routed access using an HS switch between supported HS host machines 1-N 120, A1-AN 124. For example, the HS data networks 1 102, 2 106 support use of a request for memory access protocols and includes a hash communicated from a supported HS host machine 1-N 120; A1-AN 124 to an HS switch or router to enable the HS switch or router to select or determine from its available egress ports for onward transmission of at least one data packet communicated with the hash and to enable subsequent communications from a source HS host machine that are based in part on the memory access protocols received in response to the request.

On a destination side, a destination HS host machine can provide a response memory access protocols to enable the subsequent communications. For example, a source HS host machine provides a 10-byte portion of its header having a request that is associated with the memory access protocols of a destination HS host machine and a destination HS host machine provides a 2 byte portion of its header having a response that is associated with the memory access protocols. Further, in at least the response, an attribute may be provided to indicate a data format for responses with data, such as used by graphics devices to enable compression of read data. Another attribute may be provided in the request, and supported by an appropriate response, pertaining to a number of data bytes to be operated on as part of a transaction. This may represent data carried in a request (including writes and reduction atomics), in a response (including reads) or in both (including non-reduction atomics). A further attribute may be provided in the request to trigger an appropriate response as to whether the request is targeting a coherent memory system. For example, this helps determine whether a destination HS host machine should or should not generate probes. In at least one embodiment, this attribute may also be used if the source HS host machine determines that a probe is unnecessary (for instance, due to coherence being maintained in software), and provides bits for an attribute associated with the coherent memory system only to serve as a performance hint.

In the HS data networks, such as InfiniBand® (IB) and NVlink®, there may be a difference in protocol associated with how switches process communications from an HS host machine. In at least one embodiment herein, an HS switch or router enables communication from a source host machines to a destination host machine, using their respective graphics processing units (GPUs), to properly route access requests and responses, of the memory space of the destination host machine, between the source host machine and the destination host machine. For example, the source host machine may want to understand an internal memory protocol of the destination host machine. The internal memory protocol may pertain to memory aspects, such as a size of reads, writes, or to understand coherence and completion statuses, for instance. Therefore, the communication from the source host machine can include a request associated with memory access protocols of the memory space of the destination host machine.

In at least one embodiment, the source host machine may include a hash that is based in part on a source identifier of the source host machine and a destination identifier of the destination host machine to support routing of the request. The hash may be generated by a hashing function optimized to generate a set of orthogonal bits. Further, in an example, the hash occupies a first set of bits in a header location that is adjacent to a second set of bits used by the memory access protocols. In this manner, the first set of bits may include identification with the hash to indicate presence of a request for the memory access protocols and the hash can be used by the switch to allow routing of the communication to the destination host machine, where different bits in the hash designate different routing layers, with each of the different routing layers beginning from an available egress port till the receiving host.

In at least one embodiment, a system and method that are subject to header modification to include associations with memory access protocols to address a GPU of a source host machine communicating with a destination host machine using packets that have limited space in a packet header (also referred to herein as header) to support different types of HS packet networks. For example, IB® and NVLink® may support different information in their respective headers. At least one instance of such a header may be unable to provide requests that suit the memory protocols of the destination host machine. This may be at least because of communications across protocols for instance, including because of an absence of knowledge of memory protocol of a destination host machine. The system and method herein enable, in part, a header in a communication from the source host machine, where the header can include a request associated with memory access protocols of the memory space of the destination host machine and can include a hash that, as part of a set of bits, may indicate presence of a request for the memory access protocols and can be used by the switch to allow routing of the communication.

In at least one embodiment, the system and method herein are able to communicate associations (requests and responses) for a memory access protocols and hashing in an HS switch 116 or HS router 114 of an HS data network 102; 106. Such a communication may be performed using an HS host machine 120; 124 and can be provided in part, in a header of a communication, sent to at least one HS switch 116 or HS router 114 in one of different route layers. For example, a first route layer may be upon the communication exiting the HS host machine 1-N 120 in the HS data network 1 102 and may be received an HS switch or router therein. Further, the communication with the header may be received in subsequent route layers to enable each HS switch or router in each route layer to select or determine from its available egress ports for onward transmission of a data packet from the HS host machine 1-N 120. The communication is intended for a destination HS host machine (also referred to herein as a destination host machine unless expressly stated otherwise). In at least one embodiment, the hash includes portions directed to different switches of the different route layers between the two host machines. In at least one embodiment, as a last route layer prior to exiting the HS data networks 1 102, 2 106 can support transmission of the communication to one of provided interconnect devices 130 (such as from an HS gateway 108 to an ethernet gateway 110 or ethernet switch 112) and, therefore, to a non-HS host machine, such as an ethernet host 1-N 122 of an ethernet network 104.

In at least one embodiment, the HS switch 116 or HS router 114 in each route layer is able to determine or select egress ports therein for routing the communication based on the hash from the sending HS host machines 1-N 120, A1-AN 124. For example, at least a portion of the hash can correspond to certain ones of available egress ports of the HS switch 116 or HS router 114 of a first route layer and other portions may be used to determine or select other ones of other egress ports on other HS switches or routers of other route layers. This is a repeating process performed in each route layer between the sending HS host machine and a receiving or destination HS host machine. This approach removes the HS switch 116 or HS router 114 from performing its own hashing that may otherwise result in each switch or multiple switches selecting the same egress ports repeatedly to then cause an uneven distribution of traffic through such independent but repeated selection of same egress ports of at least one HS switch 116 or HS router 114.

Therefore, the system and method herein provide both, hashing or use of hash (or hash-bits) to determine egress ports in a HS switch 116 or HS router 114 of a hash-header supportive network, like the HS data networks 1 102, 2 106, and associations with memory access protocols between a source and a destination host machines to enable subsequent communications for both. A hash-header supportive network supports transmission of headers in part of a communication that can also include a data packet meant for a receiving or destination HS host machine. In one example, an HS host machine 120, 124 can communicate, such as spraying, its communication to a host machine. A first HS switch 116 or HS router 114 in the path of such communication can receive the communication.

In at least one embodiment, the communication is from a source HS host machine to at least one receiving or destination HS host machine through at least one of the available egress ports of the first HS switch 116 or HS router 114. The first HS switch 116 or HS router 114 is able to determine the at least one of its available egress ports for transmission based in part on the hash in the header. In at least one embodiment, the hash is generated by a hashing function in the source HS host machine, where the hashing function is optimized to generate a set of orthogonal bits. Further, different bits in the hash may designate or pertain to different routing layers, with each of the different routing layers beginning from an available egress port of a first HS switch 116 or HS router 114 till a different HS switch closest to the receiving or destination HS host machine. As a result, the routing decision in one or more different routing layers are not correlated and polarization in traffic flow is avoided.

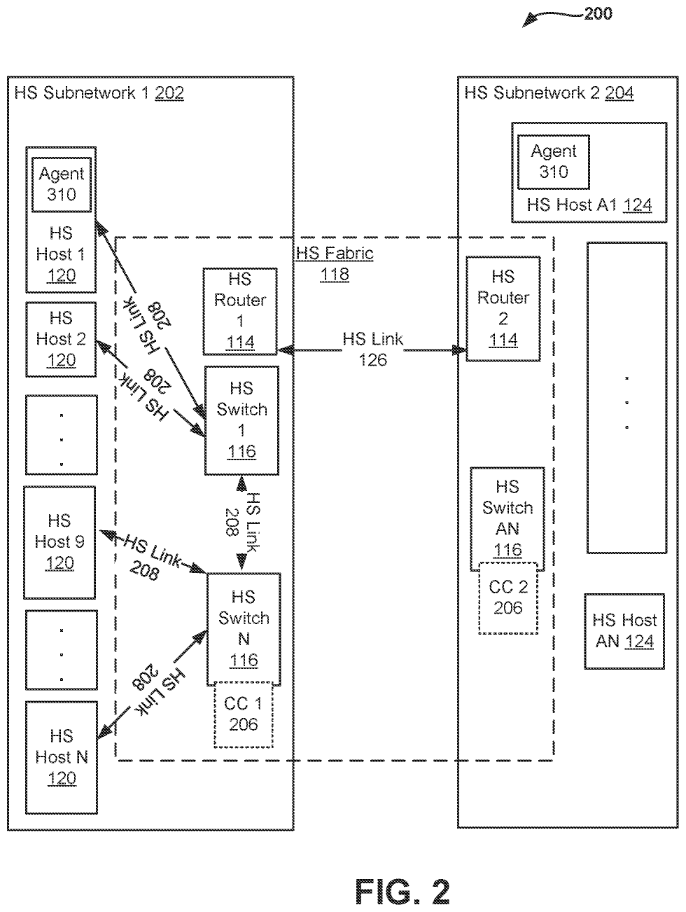

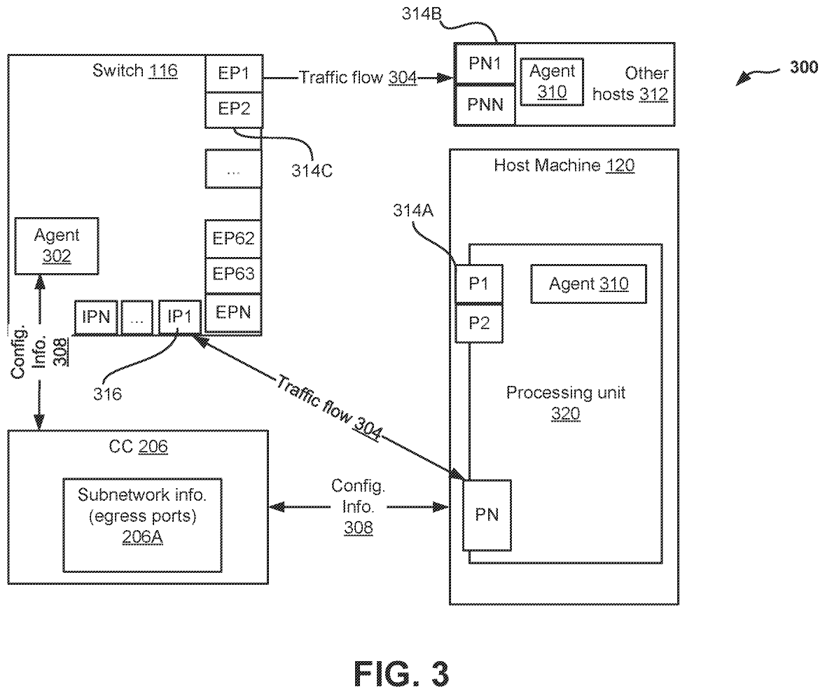

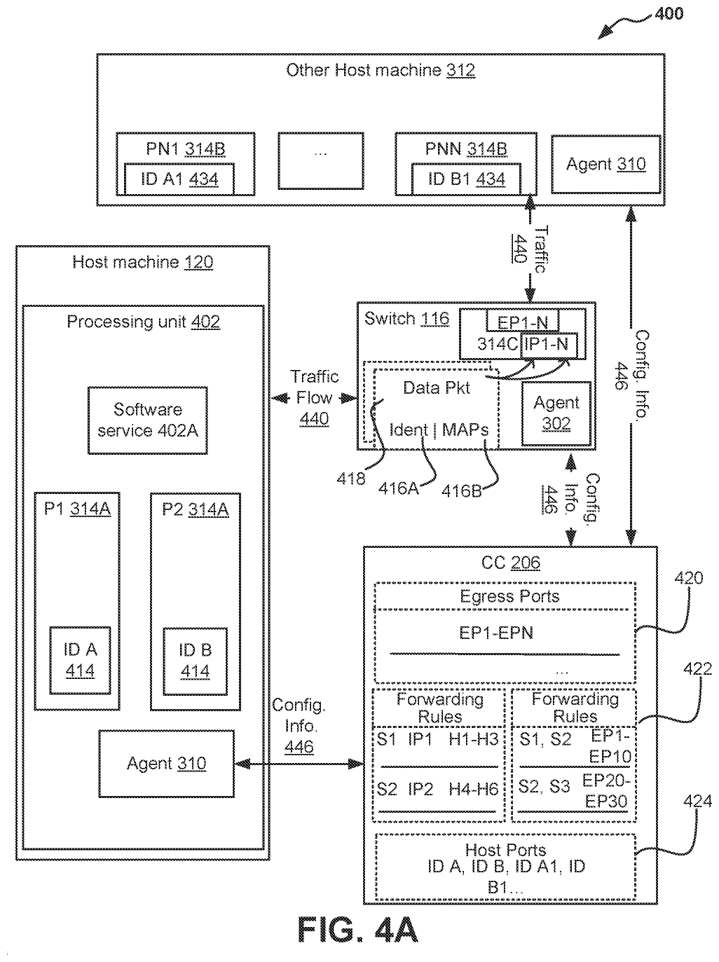

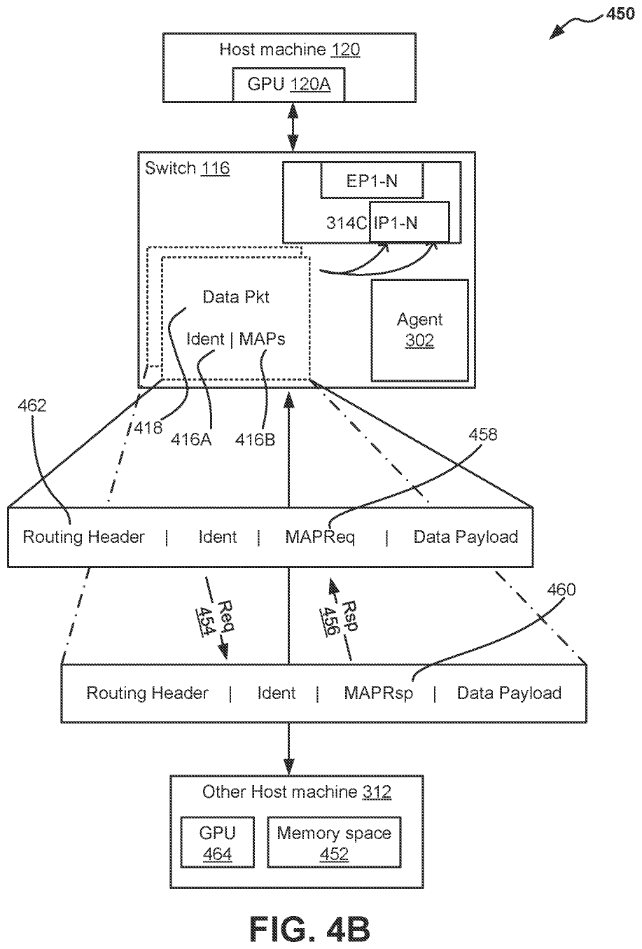

In at least one embodiment, a centralized controller that can function in an HS switch 116, an HS router 114, or an HS host machine 1-N 120; A1-AN 124, can define the hash usage for an HS switch 116 or HS router 114, based on network information (such as available egress ports) it has obtained by a periodic sweep conducted HS devices 114, 116, 120, 124 in the HS data network 1 102. Further, in FIG. 1, multiple HS host machines 1-N 120, A1-AN 124 of different HS data networks 1 102, 2 106 may interface with each other using HS switches 116 and HS routers 114; but may also support interfacing between an HS data network 1 102; 2 106 and an ethernet network 104 using interconnect devices 130. For an ethernet network 104, an ethernet switch 112 and ethernet gateways 110 may coordinate connectivity within the ethernet network 104 and may coordinate connectivity between different ethernet hosts 1-N 122 of the ethernet network 104 and other networks, such as an HS data network 1 102; 2 106 using ethernet interconnects 128. Differently, in an HS data network 1 102; 2 106, each such network relies on a centralized controller (CC) (such as illustrated and discussed with respect to at least FIGS. 2-4B) and associated agents (as in FIGS. 3-4A) to coordinate network connectivity among different HS host machines 120, 124 that communicate using HS links 126. Further, the CC may be implemented on an HS switch 116 or on at least one of the HS host machine 1-N 120; A1-AN 124, where at least one CC is provided in each HS data network 1 102; 2 106.

In one example, because an HS data network 1 102 includes CCs and agents, such as illustrated and/or discussed with respect to at least FIGS. 2-4B, these aspects are used to monitor link states of HS ports within HS host machines 120, 124. Further, a centralized controller (CC) 206 (such as in FIGS. 2-4A) is used to configure internal forwarding tables of an HS switch 116 via an agent 302 (such as in FIGS. 3, 4A). When establishing which egress ports are available for determination and selection by the switch, the CC is able to collect such information because it must be notified by all connected devices and so that it can configure one or more HS switches 116 or HS routers 114 with forwarding tables indicating the available egress ports. The CC can provide configuration information to one or more HS switches 116 or HS routers 114. The configuration information can enable each of the one or more HS switches 116 or HS routers 114 to use the hash in the header for determination or selection of at least one of its available egress ports, identified by the CC, for onward transmission of a data packet from each of the one or more HS switches 116 or HS routers 114. An HS switch routes packets from one HS link to another HS link in a same HS network, such as within each of HS subnetworks 1 202, 2 204 in FIG. 2. An HS router can route packets between the HS subnetworks 1 202, 2 204 in FIG. 2.

FIG. 2 illustrates aspects of a system 200 for header modification to include associations with memory access protocols and hashing, according to at least one embodiment. In at least one embodiment, the system and method herein enable, in part, the associations with memory access protocols using the hash to occupy a first set of bits in a header location adjacent to a second set of bits used by the memory access protocols. In addition, the first set of bits may altogether form an identifier field of the header. The hash is part of the identifier field to be used by the switch to allow routing of the communication to the destination host machine allow determination of egress ports to be used for onward transmission based in part on a hash provided from an HS host machine instead of a hash determined within the HS switch or router.

In at least one embodiment, as the routing process can be repeated across HS switches or routers in different route layers using the same hash, a full network forwarding scheme is provided. In addition, each of the different route layers may use the same hash bits. A host is used interchangeably with a host machine to describe an HS or ethernet host unless stated expressly otherwise using preceding text HS or ethernet or with respect to aspects that are HS-related versus aspects that are ethernet-related, where an HS host is exclusively within an HS network and an ethernet host is exclusively within an ethernet network. Further, such exclusivity does not restrict HS to ethernet interconnections as described throughout herein.

In at least one embodiment, FIG. 2 also illustrates that a system for determination of egress port in a data network that includes an HS switch 116 or an HS router 114 to receive a communication from an HS host machine 1-N 120; A1-AN 124, such as using an HS link 208 within a subnetwork or using an HS link 126 between subnetworks. The communication includes at least associations with memory access protocols and hashing. Further, a CC 206 may be available in each HS subnetwork 1 202, 2 204 to provide configuration information to its respective HS switch 116 or an HS router 114. The CC 206 may be combination of hardware and software or may be firmware features implemented on one HS switch N (or AN) 116 in a respective subnetwork or in a host machine HS Host N (or AN) 120; 124 of a respective subnetwork. The configuration information enables the respective HS switch 116 or an HS router 114 to use a hash in the header for the determination or selection of the at least one of the available egress ports for the transmission of the data packet onwards from the HS switch 116 or an HS router 114 to at least one receiving host machine or to a further router layer.

In at least one embodiment, FIG. 3 illustrates further aspects 300 of a system including a CC 206 for at least the hashing in header modifications that include associations with memory access protocols. The CC 206 may retain subnetwork information 206A associated with its respective subnetwork, such as information about each port on each device within the subnetwork. This information may be obtained by a sweep performed periodically by the CC 206 of all its connected devices. In one example, a CC 206 in an HS subnetwork is a device that manages the communication between multiple HS host machines, such as GPUs or CPUs, in a computer system, by acting as a central point of coordination for data transfer between the host machines. The CC 206 achieves this by configuring HS switches 116 or HS routers 114 to provide the HS links 208 of an HS fabric 118.

In at least one embodiment, the subnetwork information 206A can include information about all the HS switches 116 or HS routers 114 in its subnetwork. This information may include their respective connection status, available bandwidth, available egress ports (such as reference 420 in FIG. 4A), and data transfer rate. The information may be additionally pertaining to the data being transferred in a session, including forwarding rules (such as reference 418 in FIG. 4A), size of the data, the source and destination devices (such as by identification of host ports 424), and the priority of the data transfer. In at least one embodiment, information in the CC 206 may also include error detection and correction aspects to manage and optimize the HS links 208.

In at least one embodiment, as illustrated in FIG. 3, the CC 206 receives its information via configuration information 308 requests and responses that may be through the same HS links 208, but that is not part of the traffic flow 304. The configuration information 308 is between the CC 206 and all HS devices in the subnetwork, including the HS host machines 120, 312, and the HS switches 116. The HS devices may each have an agent 302; 310 that are software components that are responsible for managing the communication between such HS devices, their internal operating system, and the CC 206. The agents 302, 310 may be implemented as part of a device driver in each HS device and can interact with the CC 206 to control traffic flow 304 between the HS devices. However, the traffic flow 304 need not flow to the CC 206 or is at least ignored by the CC 206. The configuration information 308 may pass through the same ports of the connected devices as the traffic flow 304, however, the agents 302, 310 may recognize and respond to the configuration information 304 while ignoring the traffic flow 304.

In at least one embodiment, an agent 302; 310 in each HS device may be responsible for managing the communication between that HS device and the CC 206. However, the agent 302, 310 in each HS device may also be able to communicate amongst themselves in a subnetwork. In at least one embodiment, there may be agents 302, 310 in each HS device, but at least in the case of the HS host machines 120, 312, there may be an agent 310 to communicate configuration information to the CC 206, such as to inform about the host machines' available ports P1-N 314A, PN1-PNN 314B.

The ports P1-N 314A, PN1-PNN 314B of a respective HS host machine 120; 312 may be also associated with a respective processing unit 320, such as a GPU therein. This allows the respective processing unit 320 to form a peer-to-peer network between host machines in a subnetwork. There may be at least one agent 302 for each HS switch 116. The HS switch 116 may include its respective egress ports EP1-N 314C, representing 64 ports. However, more or less ports may also be available in such HS switches. HS routers may be able to perform similarly with respect to HS switches but may be also able to perform communication between subnetworks. In at least one embodiment, the agent 302; 310 may be also responsible for implementing features such as error detection and correction, other than flow control and data prioritization. In at least one embodiment, the HS switch 116 may include respective ingress ports IP1-N 316, where forwarding rules communicated form the CC 206 to the HS switch 116 may include indications of which hash bits to use for selecting an egress port EP1-N 314C based in part on an ingress port IP1-N 316 that receives a packet to be forwarded to a receiving HS host machine 312 via one or more layers.

In at least one embodiment, FIG. 4A illustrates still further aspects 400 of a system for header modification to include associations with memory access protocols and hashing, according to at least one embodiment. The header modification may be provided in a header of a data packet 418 of the communication. An HS switch 116 or an HS router 114 can receive a communication, such as traffic 440, from an HS host machine 120. The communication may be provided by one or more ports P1-N 314A of the HS host machine 120. The one or more ports P1-N 314A may be associated with a respective identification ID A, B 414 and with an agent 310 of its host machine. The communication includes at least a data packet 418 and a header 416A, B. The header includes a first set of bits in a first header part 416A that is in a header location that is adjacent to a second set of bits of a second header part 416B used by the memory access protocols (MAPs). The data packet 418 is for transmission to at least one receiving or destination HS host machine 312, through at least one of the available egress ports EP1-N 314C as onward traffic 440. Further, the at least one of the available egress ports EP1-N 314C is determined based in part on a hash in the first header part 416A.

In at least one embodiment, the hash in the first header part 416A is determined on the HS host machine 120 using a hash function that is part of a software service 402A and that is applied to at least one of addresses to be associated with the communication from the HS host machine 120. However, in at least one embodiment, the hash in the first header part 416A is determined on the HS host machine 120 using a hash function that is part of a software service 402A and that is applied to a source identifier (such as an address or a tag) of the source host machine and a destination identifier of the destination host machine. In at least one embodiment, the addresses used for the hash function may be one or more of a sending ID A, B 414 of a sending port P1-N 314A or a destination/receiving ID A1, B1 434 of a destination/receiving port PN1-PNN 314B of one of the other HS host machines 312. Like in the case of the HS host machine 120, these destination/receiving ports PN1-PNN 314B may be associated with an agent 310 of the HS host machine 120.

In at least one embodiment, however, the host machine is always maximizing a spread of the hash, while the CC 206 defines how the switches or routers will use the hash. In one example, the CC 206 defines the forwarding rules 422 for the route layers from a source host machine (such as between switches S1, S2, switches S2, S3, or even between a source host machine and a first switch S1) to be followed to reach the destination or receiving host machine. A switch S1 in first route layer (or first receiving switch), relative to the source host machine, can use a portion of the hash to determine its egress port to be used. This process may be repeated for each switch or router in each route layer using different portions of the hash in the header.

In at least one embodiment, the forwarding rules 422 of the CC 206 includes identification of each ingress (IP1-N) for each switch and identification of an order of hash bits to be used for forwarding the packets coming through those individual ingress ports through a selection of egress ports of each of the switches. The order of the hash bits informs the switch to use certain hash bits of the hash in the header to select the egress ports for the packets. For example, for switch S1, a packet coming through ingress port IP1 includes a hash with 10 hash bits. The switch S1 is informed by the CC 206 to use hash bits H1-H3 of H1-H10 to select egress ports for forwarding that packet. The hash bits H1-H3 may be associated with certain ones of the egress ports EP1-N. Therefore, order of hash bits is a configuration information communicated from the CC 206 to the HS switches 116 to enable the HS switch 116 to select egress ports by associating the order of hash bits with the ingress ports.

In at least one embodiment, the CC 206 is, therefore, aware about an amount of egress ports EP1-EPN 420 that are from different connected devices (such as, between switch to switch and switch to host machine) and uses this information to determine distribution of an order of hash bits. For example, the CC 206 divides the number of hash bits of a hash between each path of the router layers identified for a packet. The CC 206 informs the switch to use the number of bits in a hash, such as in an order from a left most bit to the right most bits. In each route layer, the ingress ports are associated with an order of hash bits so that the egress ports may be selected using the hash bits of the order determined.

In at least one embodiment, for a 10-bit hash, the 10 bits may be divided into two different 5-bit sets. This may be sufficient to address 32 egress ports in different connected devices in different route layers. Then, a switch-to-switch connection may use 5 of the 10 bits and a subsequent switch to host connection may use the remaining 5 bits. Further, 2 different bits for each direction may be sufficient to select egress ports and four route layers may only require 8 bits. In at least one embodiment, therefore, a maximum size of egress ports of each connected device is known to the CC 206 by performing a sweep of the connected devices. Each ingress port is associated with one or more different hash bits that may be the same for different switches and allows selection of the same egress ports for different switches.

In at least one embodiment, a CC 206 is able to receive and to provide configuration information 446 to one or more HS host machines 120, 312 and is also able to receive and to provide configuration information 446 to one or more HS switches 116. At least part of such configuration information may be retained as subnetwork information 206A. The information may include available egress ports EP1-EPN 420 of all HS switches 116 in the subnetwork; forwarding rules 422 that identify the available egress ports in each route layer to prioritize traffic flow 440; and all active host ports 424 of the HS host machines 120, 312. The CC 206 receives the configuration information 446 but also provides configuration information 446 for at least the HS switch 116 or an HS router 114. The configuration information 446 provided to the HS switch 116 or an HS router defines a usage (such as via the forwarding rules 422) of the hash based on network information that it received, including the switches' available egress ports EP1-EPN 420. In at least one embodiment, different portions of the hash in a header 416A; 416B may be used to designate or may apply to different route layers. Therefore, a portion of the hash can be used by each HS switch 116 to select at least one of its available egress ports as indicated by the CC 206, reflecting usage of the hash with respective to the available egress ports EP1-EPN 420 in each route layer.

In at least one embodiment, an HS switch 116 or a router may include two steps to forward received packets. A first step in the HS switch 116 or router may be to determine the at least one of the available egress ports EP1-N 314C based in part on at least one of different portions of the hash used to designate different route layers from the at least one of the available egress ports. A second step for the HS switch 116 or a router is to transmit the communication, such as the data packet 418, with or without the header 416A, 416B, from the HS switch 116 or router, using the at least one of the available egress ports EP1-N 314C determined in the first step and using the one of the different route layers to the at least one receiving HS host machine 312. In at least one embodiment, because the hash has portions for different route layers, the process herein for an HS switch 116 applies to all switches in the different route layers. Therefore, the header 416A, 416B is provided with the data packet 418 for all onward transmission, but a last switch that is immediately before the receiving HS host machine 312, may provide the data packet 418 alone with the header removed.

In at least one embodiment, the HS host machines 120, 312, the HS switch 116, the HS router 114, and the CC 206 are all part of a system having one or more processing units adapted with communication capabilities. In the example of an HS host machine 120; 312, the one or more processing units 320; 402 may be installed in the host machine. The one or more processing units can perform a hash function based in part on addresses to be associated with the communication from the HS host machine 120, 312. The communication capabilities may include an agent 310 for communicating with a CC 206 and for packing data into a data packet 418 with an associated header 416A; 416B. The communication capabilities enable the communication, such as the traffic 440, to be provided from the one or more processing units with the hash from the hash function included in the header 416A, 416B of the communication.

In at least one embodiment, each session between a sending HS host machine 120 and one of the receiving/destination HS host machines 312 may use the same hash in the header. However, the switch or router is further configured to update the hash to provide a new hash, based in part on the HS host machine 120 providing new communication having a new hash in a new session associated with the same sending HS host machine 120 and the same one of the receiving/destination HS host machines 312. Then, based in part on an update for the at least one of the available egress ports, where some egress ports may be inactive or busy, and based in part on the new hash to determine and update at least one of the available egress ports previously used in a session, a different one of the available egress ports is provided or enabled to transmit the new communication in the new session between to the same sending and the same one of the receiving/destination HS host machines 312.

In at least one embodiment, a CC 206 can provide configuration information to the HS switch 116 or HS router 114. The configuration information can enable the switch or router to use the hash in the header for the determination of the at least one of the available egress ports for the transmission of the data packet from the switch or router. In at least one embodiment, a software service 402A of the HS host machine 120 can support a hash function to generate the hash for the header of the data packet.

In at least one embodiment, FIG. 4B illustrates details 450 of the associations with memory access protocols. A system for a high-speed (HS) data network may include at least a source HS host machine 120 that may be an HS host machine as discussed with respect to FIGS. 1-4A. The system may include a destination or other I-IS host machine 312 that may also be an HS host machine and that may be the target of the source HS host machine 120. The system includes an HS switch 116 that is able to receive a communication, such as a data packet 418, from a source HS host machine 120 to access a memory space 452 of a destination HS host machine 312.

In at least one embodiment, the communication includes associations with memory access protocols (MAPs), as provided in the second header part 416B. For example, the second header part 416B includes a request 458 (marked as MAPReq) that is associated with memory access protocols of the memory space 452 of the destination I-IS host machine 312. The HS switch 116 is to provide a request 454 of the communication to the destination HS host machine 312. The destination HS host machine 312 provides a response 456 with its part of the communication also including associations with memory access protocols (MAPs). For example, the response 456 includes a response 460 (marked as MAPRsp) associated with the memory access protocols. The response 456 enables subsequent communications from the source HS host machine 120 to the destination HS host machine 312, where the communications are based in part on the memory access protocols received in response to the request.

In at least one embodiment, the memory access protocols define read, write, and atomic capabilities associated with a memory space 452 of the destination HS host machine 312 and may be provided as part of different attributes in the MAPReq 458 or MAPRsp 460 header parts. For example, one or more of the MAPReq 458 or MAPRsp 460 header parts may include a header attribute, an address extension attribute, and one or more of a byte enable or data attribute. Further, a MAPRsp 460 header part may include an attribute that can be used to indicate a data format for responses with data, such as used by graphics devices to enable compression of read data.

In another example, an attribute of a MAPReq 458 header part, and supported by an appropriate response in an attribute of a MAPRsp 460 header part, pertains to a number of data bytes to be operated on as part of a transaction. This may represent data carried in a request (including writes), in a response (including reads) or in both (including atomics). A further attribute that may be provided in a MAPReq 458 header part, to trigger an appropriate response, may pertain to whether the request is targeting a coherent memory system. For example, this helps determine whether a destination HS host machine should or should not generate probes. In at least one embodiment, this field may also be used if the source HS host machine determines that a probe is unnecessary and provides bits for a field associated with the coherent memory system only to serve as a performance hint.

In at least one embodiment, the communication further includes a partition key that may be part of a header part marked as routing header 462. The partition key may be used by at least one further switch, other than the first switch I-IS 116. For example, at least one further switch in the routing between the source host machine and the destination host machine can use the partition key to forward the communication based at least in part on the partition key being associated with a stored key of the at least one further switch. In at least one embodiment, the partition key is to determine a source host machine's membership in a partition and can be checked at a destination host machine to make sure communication between them is allowed.

In at least one embodiment, the system includes a source graphics processing unit (GPU) 120A is adapted with communication capabilities. Further, the source GPU is to be installed in a source HS host machine 120. The source GPU 120A to perform a hash function based in part on a source identifier, such as an address, of the source host machine and a destination identifier of the destination host machine to provide a hash for the identifier header part 416A of the data packet 418. The hash is to occupy a first set of bits (such as, the identifier header part 416A) in a header location adjacent to a second set of bits (such as, the MAPs header part 416B) used by the memory access protocols, as illustrated in FIG. 4B. Further, the hash is to be used by the HS switch 116 to allow routing of the communication to the destination host machine.

In at least one embodiment, a source GPU 120A is to encompass the memory access protocols of a destination GPU 464 within the communication, such as in the header part 416B, using an identifier header part 416A that is in a bit range that is arranged prior to the memory access protocols. The identifier is to inform a destination GPU 464 of the location of the memory access protocols within the communication. The HS switch 116 may be further adapted to include a map of destination identifiers that comprise the destination host machine and a group of egress ports associated with the destination host machine.

In at least one embodiment, therefore, one or more processing units, such as the GPUs 120A, 464 may be associated with at least one HS switch 116 or HS router 114 and may enable the at least one HS switch 116 or HS router 114 to receive a communication, such as data packet 418, from a source host machine. The communication may include a request (MAPReq) 458 associated with memory access protocols of a memory space 452 of a destination US host machine 312. The communication may be provided to the destination US host machine 312 to enable subsequent communications from the source US host machine 120, where the subsequent communications are based in part on the memory access protocols received in a response (MAPRsp) 460 to the request (MAPReq) 458.

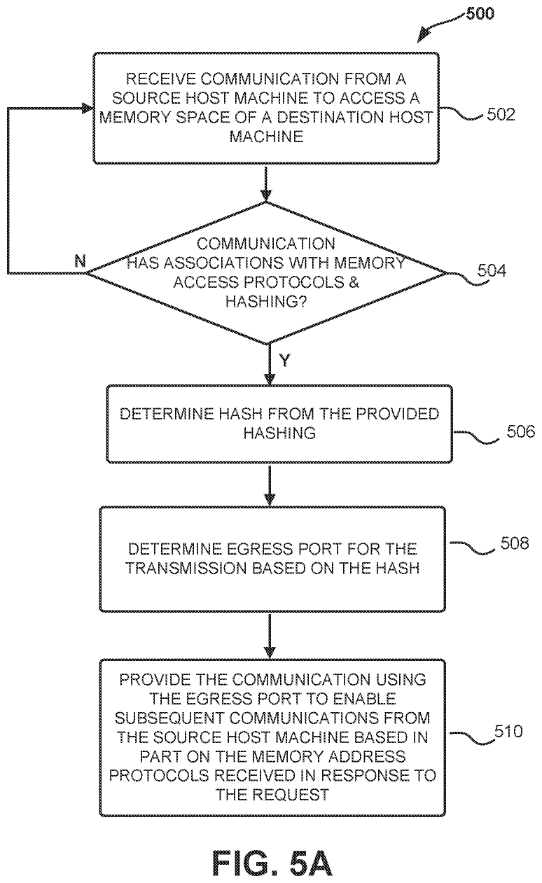

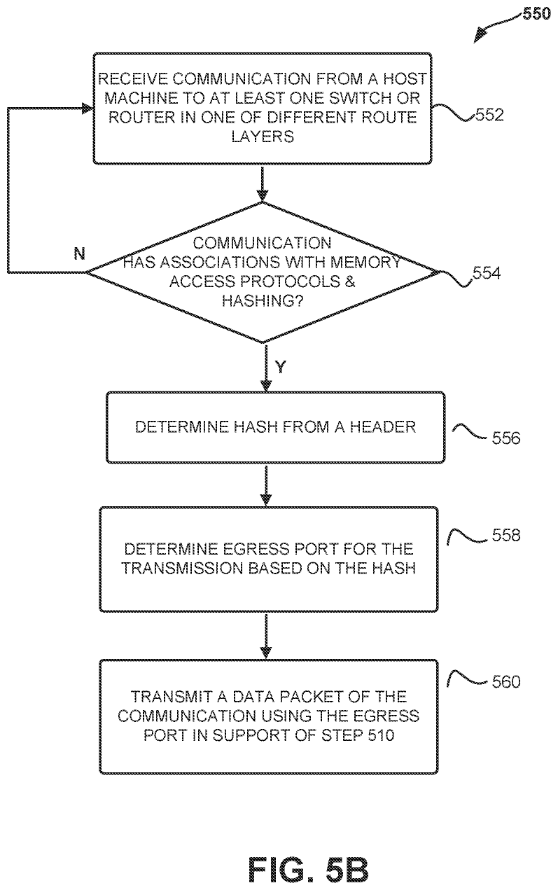

In at least one embodiment, FIG. 5A illustrates a process flow or method 500 for a system for header modification to include associations with memory access protocols and hashing. The method 500 for communication in high-speed (HS) data networks includes receiving 502, in a switch, a communication from a source host machine to access a memory space of a destination host machine. The method 500 includes determining 504 that the communication includes a request associated with memory access protocols of the memory space of the destination host machine. The method 500 may also include determining 504 that the communication includes hashing. A hash may be determined 506 from the hashing and an egress port may be determined 508 in the switch, using the hash, for onward transmission of the communication. In at least one embodiment, the method 500 includes providing 510 the communication to the destination host machine to enable subsequent communications from the source host machine that are based in part on the memory access protocols received in response to the request. Further, the communication may be provided 510 to the destination host machine using the egress port of step 508.

In at least one embodiment, the method 500 include use of memory access protocols that define read, write, and atomic capabilities associated with a memory of the destination host machine. Further, the method 500 includes support for the communication to further have a partition key to be used by at least one further switch between the source host machine and the destination host machine to forward the communication. For example, based at least in part on the partition key being associated with a stored key of the at least one further switch, the at least one further switch can determine a source host machine's membership in a partition, which can also be checked at a destination host machine to make sure that the communication is allowed.

In at least one embodiment, the method 500 includes providing communication capabilities in a source graphics processing unit (GPU) that is to be installed in the source host machine. The method 500 includes performing, using the source GPU, a hash function based in part on a source identifier of the source host machine and a destination identifier of the destination host machine to provide a hash. Then, the hash can be arranged to occupy a first set of bits in a header location that is adjacent to a second set of bits used by the memory access protocols. Further, the hash can be used by the switch to allow routing of the communication to the destination host machine. In at least one embodiment, the method 500 includes encompassing, using a source GPU, the memory access protocols of a destination GPU within the communication using an identifier in a bit range that is arranged prior to the memory access protocols. The method 500 includes enabling a destination GPU to determine a location of the memory access protocols within the communication based in part on the identifier.

In at least one embodiment, the method 500 includes supporting the communication further by including within it a request header attribute, an address extension attribute, and one or more of a byte enable or data attribute. In addition, the switch of the method 500 herein can include a map of destination identifiers. The destination identifiers include the destination host machine and a group of egress ports of the switch that are associated with the destination host machine.

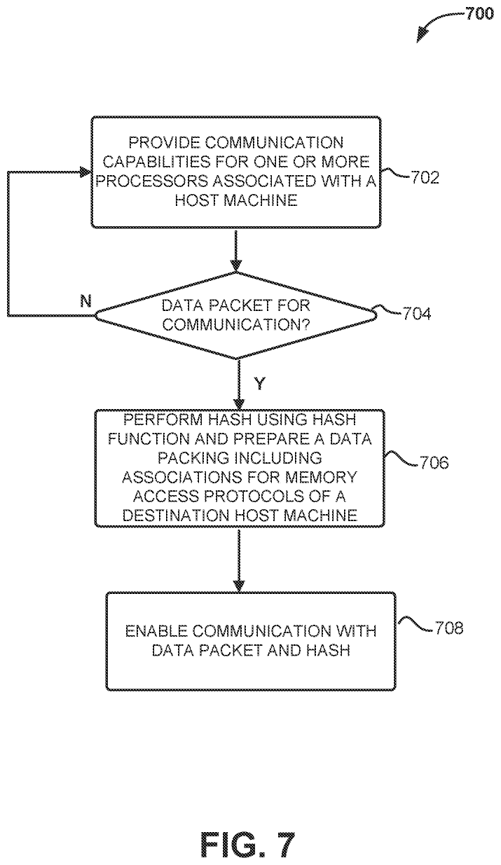

In at least one embodiment, FIG. 5B illustrates a process flow or method 550 for a system for header modification to include associations with memory access protocols and hashing, according to at least one embodiment. The method 550 may be performed together with the method 500 of FIG. 5A for the same communication. The method 550 includes receiving 552 a communication from a host machine in at least one switch or a router of one of different route layers. The method includes verifying or determining 554 that the communication includes the associations with memory access protocols and the hashing. The method includes one further determining 556 step for a hash from the header, such as from the hashing. Another further determining 508 step is performed in the method 550 for at least one of available egress ports of the at least one switch or router that can be used for transmission of the data packet to at least one receiving host machine. The at least one of the available egress ports is determined based at least in part on a hash in the header. The method includes transmitting 560 the data packet of the communication, in support of step 510, using the at least one of the available egress ports determined in step 558. In at least one embodiment, the method 550 includes a step or sub-step for determining, on the host machine, the hash to be provided in the header based on a hash function applied to at least addresses to be associated with the communication from the host machine. This is detailed in a method 700 in FIG. 7.

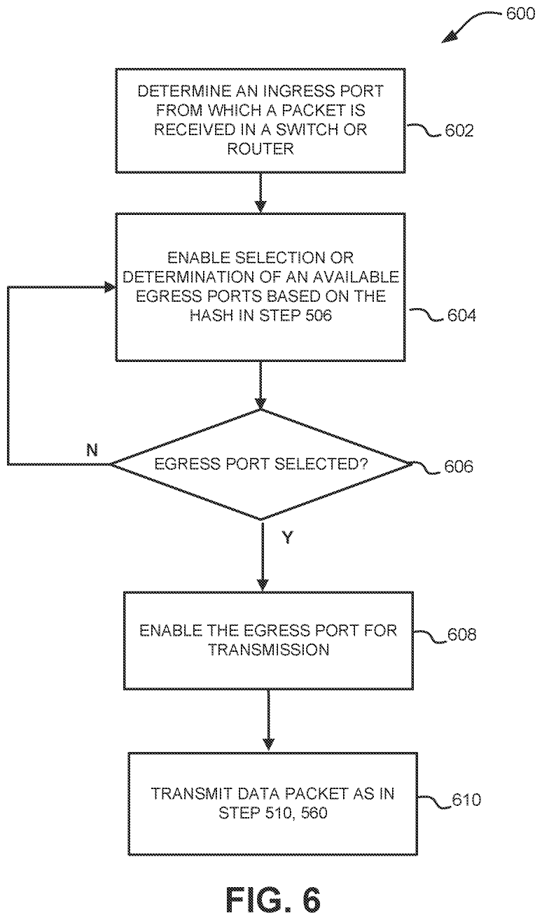

In at least one embodiment, FIG. 6 illustrates process flow or method 600 for a system for header modification to include associations with memory access protocols and hashing. The method 600 includes determining 602 an ingress port of at least one switch or router of one of the different route layers through which a packet is received. The method 600 includes enabling 604 selection or determination occurs for the at least one of the available egress ports to be used in the communication between a sending host machine and a destination/receiving host machine. The selection or determination is based in part on one of the different portions of the hash, such as using an order of the hash that is associated with the ingress port. The different portions of the hash are used to designate the different route layers beginning from the at least one of the available egress ports.

The method 600 includes verifying 606 that one of the available egress ports is selected or determined. The method 600 includes enabling 608, for the at least one switch or router, the one of the available egress ports for transmission. The method 600 includes transmitting 610 the data packet from the switch or router using the at least one of the available egress ports and using the one of the different route layers to the at least one receiving host machine, as in steps 510; 560.

In at least one embodiment, FIG. 7 illustrates a process flow or method 700 for a system for header modification to include associations with memory access protocols and hashing. The method 700 may be performed in a host machine adapted for an HS network with an agent and in communication with a CC as described throughout herein. The method includes providing 702 one or more processing units with communication capabilities and installed in the host machine. The providing 702 step may be supported by installing, in a host machine, one or more GPUs that are capable of peer to peer communication using an agent in communication with a CC. The method 700 includes verifying 704 that a data packet is for communication from the one or more processing units. The method 700 includes performing 706, using the one or more processing units, a hash function based in part on addresses to be associated with the communication from the host machine. The addresses may be an address of the hosting machine and an address of the destination or receiving host machine. The addresses may be port identifiers of these respective host machines. The method 700 also includes preparing 706 the data packet to include the associations for the memory access protocols of a destination host machine.

The method 700 includes enabling 708, using the communication capabilities, the communication from the one or more processing units with the hash from the hash function included in the header of the communication. In at least one embodiment, one of such methods 500-700 may include a step or a sub-step for updating the hash to provide a new hash, such as sent from a host machine and stored in the switch. The updating may be based in part on the host machine providing new communication having the new hash in a new session associated with the receiving host machine. The new session may be some period after a prior communication between the host machine and the receiving host machine has ended.

In at least one embodiment, one of such methods 500-700 may include a step or a sub-step for updating the at least one of the available egress ports previously used between these host machines based in part on the new hash. This is to provide a different one of the available egress ports to transmit the new communication to the receiving host machine. In at least one embodiment, one of such methods 500-700 may include a step or a sub-step for providing, using a centralized controller, configuration information to the switch or router. The configuration information may include forwarding rules of the available ports of the destination host machine or subsequent switches and routers of the remaining route layers, for instance.

In at least one embodiment, one of such methods 500-700 may include a step or a sub-step for enabling, using the configuration information, the switch or router to use the hash in the header for the selection of the at least one of the available egress ports for the transmission of the data packet from the switch or router. For example, using the forwarding rules, the switch is able to apply the appropriate portion of the hash from the header to determine its egress ports to be used for the transmission. In at least one embodiment, one of such methods 500-700 may include a step or a sub-step for enabling, using a software service of the host machine, a hash function to generate the hash for the header of the data packet.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors.

In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

Accordingly, in at least one embodiment, computer systems are configured to implement one or more services that singly or collectively perform operations of processes described herein and such computer systems are configured with applicable hardware and/or software that allow performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. References may also be made to providing, outputting, transmitting, sending, or presenting analog or digital data. In at least one embodiment, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system for a high-speed (HS) data network, comprising:
a switch to receive a communication from a source host machine to access a memory space of a destination host machine, the communication comprising a request associated with memory access protocols of the memory space of the destination host machine, and to provide the communication to the destination host machine to enable subsequent communications from the source host machine that are based in part on the memory access protocols received in response to the request.

2. The system of claim 1, wherein the memory access protocols define read, write, and atomic capabilities associated with the memory space of the destination host machine.

3. The system of claim 1, wherein the communication further comprises a partition key to be used by at least one further switch between the source host machine and the destination host machine to forward the communication based at least in part on the partition key being associated with a stored key of the at least one further switch.

4. The system of claim 1, further comprising:
a source graphics processing unit (GPU) adapted with communication capabilities and to be installed in the source host machine, the source GPU to perform a hash function based in part on a source identifier of the source host machine and a destination identifier of the destination host machine to provide a hash, the hash to occupy a first set of bits in a header location adjacent to a second set of bits used by the memory access protocols and the hash to be used by the switch to allow routing of the communication to the destination host machine.

5. The system of claim 1, further comprising:
a source GPU to encompass the memory access protocols of a destination GPU within the communication using an identifier in a bit range that is arranged prior to the memory access protocols, wherein the identifier is to inform a destination GPU of the location of the memory access protocols within the communication.

6. The system of claim 1, wherein the communication further comprises a request header attribute, an address extension attribute, and one or more of a byte enable or data attribute.

7. The system of claim 1, wherein the switch is further to comprise a map of destination identifiers that comprise the destination host machine and a group of egress ports associated with the destination host machine.

8. A method for communication in high-speed (HS) data networks, the method comprising:
receiving, in a switch, a communication from a source host machine to access a memory space of a destination host machine;
determining that the communication comprises a request associated with memory access protocols of the memory space of the destination host machine; and
providing the communication to the destination host machine to enable subsequent communications from the source host machine that are based in part on the memory access protocols received in response to the request.

9. The method of claim 8, wherein the memory access protocols define read, write, and atomic capabilities associated with the memory space of the destination host machine.

10. The method of claim 8, wherein the communication further comprises a partition key to be used by at least one further switch between the source host machine and the destination host machine to forward the communication based at least in part on the partition key being associated with a stored key of the at least one further switch.

11. The method of claim 8, further comprising:
providing communication capabilities in a source graphics processing unit (GPU) that is to be installed in the source host machine;
performing, using the source GPU, a hash function based in part on a source identifier of the source host machine and a destination identifier of the destination host machine to provide a hash; and
arranging the hash to occupy a first set of bits in a header location adjacent to a second set of bits used by the memory access protocols and the hash to be used by the switch to allow routing of the communication to the destination host machine.

12. The method of claim 8, further comprising
encompassing, using a source GPU, the memory access protocols of a destination GPU within the communication using an identifier in a bit range that is arranged prior to the memory access protocols; and
enabling a destination GPU to determine a location of the memory access protocols within the communication based in part on the identifier.

13. The method of claim 8, wherein the communication further comprises a request header attribute, an address extension attribute, and one or more of a byte enable or data attribute.

14. The method of claim 8, wherein the switch is further to comprise a map of destination identifiers that comprise the destination host machine and a group of egress ports associated with the destination host machine.

15. A system comprising:
one or more processing units to be associated with at least one switch or router and to enable the at least one switch or router to receive a communication from a source host machine, the communication comprising a request associated with memory access protocols of a memory space of a destination host machine, the communication to be provided to the destination host machine to enable subsequent communications from the source host machine that are based in part on the memory access protocols received in response to the request.

16. The system of claim 15, wherein the memory access protocols define read, write, and atomic capabilities associated with the memory space of the destination host machine.

17. The system of claim 15, wherein the communication further comprises a partition key to be used by at least one further switch between the source host machine and the destination host machine to forward the communication based at least in part on the partition key being associated with a stored key of the at least one further switch.

18. The system of claim 15, wherein at least one of the one or more processing units are further adapted with communication capabilities and to be installed in the source host machine to perform a hash function based in part on a source identifier of the source host machine and a destination identifier of the destination host machine to provide a hash, the hash to occupy a first set of bits in a header location adjacent to a second set of bits used by the memory access protocols and the hash to be used by the switch to allow routing of the communication to the destination host machine.

19. The system of claim 15, wherein the one or more processing units are further to encompass the memory access protocols of a destination GPU within the communication using an identifier in a bit range that is arranged prior to the memory access protocols, wherein the identifier is to inform a destination GPU of the location of the memory access protocols within the communication.

20. The system of claim 15, wherein the communication further comprises a request header attribute, an address extension attribute, and one or more of a byte enable or data attribute.
